(19) United States
(12) Patent Application Publication
(10) Pub. No.: US 2026/0365175 A1
(43) Pub. Date: Nov. 19, 2026

(54) VEHICLE SYSTEM AND METHOD OF DRIVING VEHICLE SYSTEM

(71) Applicant: HL MANDO CORPORATION, Pyeongtaek-si (KR)

(72) Inventor: Jinsoo KIM, Pyeongtaek-si (KR)

(73) Assignee: HL MANDO CORPORATION, Pyeongtaek-si (KR)

(21) Appl. No.: 19/673,767

(22) Filed: May 11, 2026

(30) Foreign Application Priority Data
May 12, 2025 (KR) 10-2025-0060902

(51) Int. Cl. B60W 30/18; B60W 10/184; B60W 10/20; B60W 40/105; B60W 40/114; B60W 50/00; B60W 50/029; B60W 60/00; B62D 7/14; B62D 9/00; G06V 20/56

(52) U.S. Cl. CPC B60W 30/18163; B60W 10/184; B60W 10/20; B60W 40/105; B60W 40/114; B60W 50/029; B60W 60/001; B62D 7/14; B62D 9/005; G06V 20/588; B60W 2050/0031; B60W 2420/403; B60W 2420/408; B60W 2510/182; B60W 2510/20; B60W 2520/06; B60W 2520/28; B60W 2552/10; B60W 2710/18; B60W 2710/20

(57) ABSTRACT

Embodiments of the present disclosure relate to a vehicle system and a method of driving a vehicle. The vehicle system includes an optical sensor configured to identify lanes and generate lane image data, and a controller configured to control a front wheel steering device based on the lane image data. When the controller determines that the front wheel steering device is not normally controlled, the controller sets a steering direction based on the lane image data and controls a braking state of one or more wheels or a rear wheel steering angle of a rear wheel steering device to determine a traveling direction of the vehicle. Accordingly, steering and wheels are controlled so that the vehicle can continue driving, thereby improving safety and reliability even in the event of a failure of a steering system.

### CROSS-REFERENCE TO RELATED APPLICATION(S)

The present application claims priority under 35 U.S.C. § 119 (a) to Korean patent application number 10-2025-0060902 filed on May 12, 2025, which is incorporated herein by reference in its entirety.

### BACKGROUND

### Technical Field

Embodiments of the present disclosure relate to a vehicle system and a method of driving the vehicle.

### Description of Related Art

Recently, in new concept vehicles such as autonomous vehicles and electric vehicles, application of by-wire type chassis systems such as a Steer-by-Wire (SbW) system is active.

Although the SbW system performs steering using only electrical signals without a mechanical connection, there is a limitation in that steering control becomes impossible when front wheel steering becomes impossible due to a communication failure or the like.

Accordingly, a failover control technology capable of maintaining steerability of a vehicle even in a failure situation of a front wheel SbW system is required.

### BRIEF SUMMARY

Particularly, in an autonomous driving environment, since a vehicle is required to follow a lane-based path without a driver's manipulation, the necessity for a technology to secure steerability by integratedly controlling rear wheel steering and left and right differential braking even in the event of a steering failure is increasing.

For example, embodiments of the present disclosure may provide a vehicle system in which failover may be driven even if there is a defect in a steering device.

Embodiments of the present disclosure may provide a vehicle system capable of maintaining steering of a vehicle even if there is a failure in a steering device.

Embodiments of the present disclosure may provide a vehicle system in which autonomous driving is stably maintained even if there is a failure in a steering device during autonomous driving.

Embodiments of the present disclosure may provide a vehicle system comprising: an optical sensor configured to identify one or more lanes serving as a basis for a driving direction of a vehicle during autonomous driving and generate lane image data; and a controller configured to control a front wheel steering device of the vehicle based on the lane image data, wherein, in response to the controller determining that the front wheel steering device is not normally controlled, the controller is configured to set a steering direction of the vehicle based on the lane image data in a first period, the first period being a period during which the steering direction is determined, and then control a braking state of one or more wheels of the vehicle or a rear wheel steering angle of a rear wheel steering device of the vehicle to determine a traveling direction of the one or more wheels based on the steering direction in a second period, the second period being a period subsequent to the first period during which the steering direction is applied.

Embodiments of the present disclosure may provide a method of driving a vehicle, comprising: determining, by a controller, whether a front wheel steering device under electronic control is normally controlled; identifying, by the controller, lane information including one or more lanes on which the vehicle is driving and a state of the vehicle; generating, by the controller, a path along which the vehicle is to travel; estimating, by the controller, a steering direction of the front wheel steering device; generating, by the controller, a steering control signal such that the vehicle moves in the steering direction; and controlling, by the controller, a braking state of one or more wheels of the vehicle or a rear wheel steering angle of a rear wheel steering device to determine a traveling direction of the one or more wheels based on the steering control signal.

According to the present embodiments, it is possible to provide a vehicle system in which failover can be performed even if there is a failure in a steering device.

According to the present embodiments, it is possible to provide a vehicle system capable of maintaining steering of a vehicle even if there is a failure in a steering device.

According to the present embodiments, it is possible to provide a vehicle system in which autonomous driving can be stably maintained even if there is a failure in a steering device during autonomous driving.

### BRIEF DESCRIPTION OF THE SEVERAL VIEWS OF THE DRAWINGS

FIG. 1 is a diagram of a vehicle system according to embodiments of the present disclosure.

FIG. 2 illustrates a controller according to embodiments of the present disclosure.

FIG. 3 illustrates vehicle system capable of autonomous driving according to embodiments of the present disclosure.

FIG. 4 illustrates a partial failure state of a vehicle system according to embodiments of the present disclosure.

FIGS. 5 and 6 are flowcharts of a method of driving a vehicle according to embodiments of the present disclosure.

FIG. 7 illustrates a lane trajectory model of a vehicle system according to embodiments of the present disclosure.

FIG. 8 is a diagram for explaining a vehicle dynamics modeling according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to”, “contacts or overlaps”, etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc., each other via a fourth element. Here, the second element may be included in at least one of two or more elements that “are connected or coupled to”, “contact or overlap”, etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

The present disclosure describes a control strategy for an autonomous vehicle that maintains steering capability when a front wheel steer by wire system becomes unavailable. Rather than relying on mechanical redundancy or reducing functionality, the system operates in two stages. In a first stage, a desired steering direction is determined using lane information and a vehicle dynamics model. In a second stage, that direction is achieved through alternative actuators, including rear wheel steering and or differential braking. This separation between determining a target direction and executing control enables continued path tracking without use of the front wheel steering device.

The system further reconstructs steering behavior without direct front steering feedback by estimating the front wheel steering angle from vehicle state variables such as lateral acceleration and yaw rate, and optionally from learned models based on historical data. A model predictive control approach is then applied to compute control inputs that allow the vehicle to follow a desired path while accounting for actuator limits. Rear wheel steering and differential braking may be applied independently or together to generate the required yaw moment, allowing coordinated control of vehicle motion under conditions where front steering is unavailable.

The approach supports continued autonomous driving functions, including lane keeping and lane changing, rather than limiting operation to a minimal risk condition. It incorporates sensor fusion for lane recognition and vehicle state estimation, real time path generation adapted to available actuators, and failure detection based on discrepancies between commanded and measured steering responses. The result is an integrated control framework in which braking and rear wheel steering are used to achieve directional control when the primary steering mechanism cannot be used.

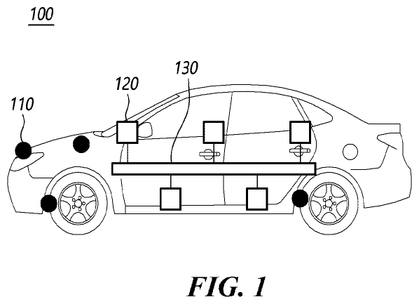

FIG. 1 illustrates a vehicle system 100 according to embodiments of the present disclosure.

The vehicle system 100 may comprise a plurality of sensors 110, a plurality of electronic controllers 120, and a controller 130.

The plurality of sensors 110 may sense an internal signal of a vehicle or an external signal of the vehicle.

The plurality of sensors 110 may comprise various types of sensors. The plurality of sensors 110 may comprise one or more sensors of the same type.

The plurality of sensors 110 may be a camera sensor. A camera sensor may capture an image of a front side or a lateral side through a CMOS-based image sensor, and may enable recognition of a lane, surrounding vehicles, pedestrians, and the like.

The plurality of sensors 110 may be a radar sensor. A radar sensor may measure a distance and a relative speed of a front object with high precision based on millimeter waves (e.g., 77 GHz).

The plurality of sensors 110 may be a LiDAR sensor. A LiDAR sensor may emit a pulse laser and receive a reflected signal to configure three-dimensional spatial information around a vehicle. Hereinafter, the LiDAR sensor may be defined as a lidar sensor or an optical device.

The plurality of sensors 110 may be an inertial measurement unit (IMU). An inertial measurement unit comprises a 3-axis accelerometer and a 3-axis gyroscope, and may collect dynamic behavior information such as linear acceleration, angular velocity, and attitude change of a vehicle in real time. The inertial measurement unit may be utilized for driving stability analysis of the vehicle, dynamic estimation during cornering, or position estimation correction (e.g., GPS assistance), and the like.

The plurality of sensors 110 may be a wheel speed sensor. A wheel speed sensor is mounted on each wheel, and may measure a rotational speed through a combination of a toothed ring and a magnetic sensor or an optical sensor. This sensor is used as a key input device for driving stabilization devices such as an Anti-lock Braking System (ABS), a Traction Control System (TCS), and an Electronic Stability Control (ESC), and may also be utilized for actual driving speed of the vehicle, slip ratio, road surface condition estimation, and the like.

The plurality of sensors 110 may be a wheel speed sensor. A wheel speed sensor is mounted on each wheel, and may measure a rotational speed through a combination of a toothed ring and a magnetic sensor or an optical sensor. This sensor is used as a key input value for driving stabilization devices such as ABS, TCS, and ESC, and may also be utilized for estimating an actual driving speed of the vehicle, slip ratio, road surface condition, and the like.

The plurality of sensors 110 may be brake pressure sensors. A brake pressure sensor is mounted on a master cylinder or a hydraulic line of each brake unit to measure a pressure value in real time during brake operation. Through this, a braking intention and a braking intensity may be identified, and the brake pressure sensor may be utilized in connection with estimation of a road surface friction coefficient based on braking, prediction of a braking distance, and ABS/ESC control.

The plurality of sensors 110 may be GPS or other position sensors. A GPS sensor estimates an absolute position of the vehicle using satellite signals, and high-precision measurement is usually possible through a Real Time Kinematic (RTK) method or Differential GPS (DGPS). The position sensor data may be utilized as basic data for map-based path following, high-precision lane matching, and determination of lane change and curve driving.

The plurality of sensors 110 may be wheel angular velocity sensors. A wheel angular velocity sensor may measure a rotational speed of each wheel of the vehicle in real time by detecting a magnetic field change or an optical signal.

The plurality of sensors 110 may be engine torque detection sensors. An engine torque detection sensor may indirectly estimate an engine output torque by measuring a torsional strain of a crankshaft or a flywheel, and may be implemented in a strain gauge-based or magnetic induction manner.

The plurality of sensors 110 may comprise a crankshaft position sensor, a 3-axis acceleration sensor, an oxygen sensor, an air flow sensor, a gyroscope sensor, a steering angle sensor, and the like.

The plurality of sensors 110 may be electrically connected to a plurality of electronic controllers 120. The plurality of sensors 110 may transmit detection data to the plurality of electronic controllers 120.

The electronic controller 120 may process various types of signal data collected from a sensor network. The electronic controller 120 may control driving, braking, steering, body, and convenience functions of the vehicle in real time by performing control logic specialized for each domain.

The electronic controller 120 may generally be classified and arranged based on a functional domain or a location within the vehicle. Each of the plurality of electronic controllers 120 may be implemented based on a hardware and firmware architecture suitable for a corresponding domain. The electronic controller 120 is connected to an in-vehicle network infrastructure (e.g., CAN, LIN, FlexRay, etc.) and may exchange control commands through organic communication with a controller 130.

CAN communication is a vehicle network standard, enabling communication in a form of a bus structure between a plurality of nodes through a single twisted pair line, and may support a collision avoidance-based message priority processing function. The CAN communication may be communication used for data transmission between the plurality of sensors and the plurality of electronic controllers 120. The CAN communication may be utilized for delivery of control commands between the controller 130 and the plurality of electronic controllers 120.

The plurality of electronic controllers 120 may be configured as domain-dedicated units for powertrain, chassis, body, and convenience areas. For example, a powertrain electronic controller may be configured as an engine control module and a motor control unit. A chassis electronic controller may comprise an Electronic Stability Control (ESC) unit and an Electric Power Steering (EPS) unit. A body electronic controller may comprise a Body Control Module (BCM) and a Tire Pressure Monitoring System (TPMS) unit.

The electronic controller 120 is not limited to a role of simply collecting sensor data and delivering the sensor data to the controller 130, but may be configured as an independent control node that performs a real-time control algorithm specialized for each functional domain within the vehicle.

The electronic controller 120 may perform functions related to camera image capturing. A vehicle system 100 may comprise a camera that captures an image of the outside or inside of the vehicle as the plurality of sensors 110. The corresponding electronic controller 120 collects high-resolution image data input in real time from an RGB or IR-based camera, and performs omnidirectional environment recognition such as object detection, lane tracking, and traffic light recognition through an image recognition algorithm (e.g., CNN, YOLO, etc.).

The electronic controller 120 may perform functions related to torque measurement of an engine. Engine torque may be estimated based on various data such as a torsion amount of a crankshaft, a rotational speed, a fuel injection amount, and ignition timing. The corresponding electronic controller 120 calculates a current output torque using data input through a torque sensor mounted on the engine or an indirect calculation module, and may adjust a fuel injection amount and an ignition map in real time based on the calculated current output torque. The corresponding electronic controller 120 drives a multi-dimensional map-based engine torque model by combining data collected from a strain gauge-based torque detection sensor, a Mass Air Flow (MAF) sensor, a crankshaft position sensor, and the like, and a result of this calculation may be used in linkage with transmission control and vehicle stability control.

The electronic controller 120 may perform functions related to wheel angular velocity sensing. A sensor that precisely measures a rotational speed of each wheel during driving of the vehicle may be defined as a wheel angular velocity sensor or an ABS sensor. The corresponding electronic controller 120 may generally be an Electronic Stability Control Unit (ESC ECU) or a Brake Control ECU. The wheel angular velocity sensor may be a sensor to which a non-contact magnetic sensor (e.g., Hall Effect Sensor) or a magnetic resistance method (MR Sensor) is applied. The wheel angular velocity sensor may determine an instantaneous rotational speed (e.g., RPM) of a wheel in real time by detecting rotation of a tone ring or a magnetic disk attached to a rotating body. The wheel angular velocity sensor may be mounted on each of four wheels, and may detect operations such as braking imbalance, slip, and excessive turning by precisely monitoring a difference in rotation of each wheel.

The ESC ECU receiving such data plays an important role in maintaining lateral stability and straightness of the vehicle, and may drive various sub-control logics such as an Anti-lock Braking System (ABS), a Traction Control System (TCS), and Vehicle Dynamics Control (VDC). The ESC ECU also merges and analyzes other chassis-related data such as wheel acceleration, a steering angle, brake pressure, and a vehicle speed to generate a yaw control command and an understeer/oversteer correction command for applying individual braking force to a specific wheel if necessary.

The electronic controller 120 may perform functions related to wheel acceleration sensing. A sensor that measures 3-axis acceleration data of a wheel in real time is a wheel acceleration sensor, and the electronic controller 120 associated with this sensor may be an Electronic Stability Control (ESC) ECU or a Chassis Domain Controller. The corresponding electronic controller 120 may maintain posture stability of the vehicle by tracking movement of each wheel in real time and analyzing lateral force, longitudinal force, a slip rate, and the like occurring during driving. The corresponding electronic controller 120 may also be connected to a 6-axis IMU, a steering angle sensor, and a brake pressure sensor of the vehicle to perform integrated control.

The electronic controller 120 may be a chassis domain electronic controller configured to control a braking system of the vehicle in real time. A brake electronic controller 120 related to brakes may collect various input signals such as a brake pressure sensor, a wheel angular velocity sensor, an acceleration sensor, and a steering angle sensor, and based on this, may perform a control algorithm for precisely adjusting braking torque according to a deceleration request of the vehicle. The brake electronic controller 120 may integrally control sub-functional modules such as an anti-lock braking system (ABS), electronic brakeforce distribution (EBD), electronic stability control (ESC), and brake assist (BA), and when a wheel slip state or a sudden braking situation occurs, may secure safety and straight-line stability of the vehicle by adjusting independent braking force for each wheel. This unit may be typically integrated within a brake module housing or may be separately disposed as a part of a chassis electronic control domain.

The electronic controller 120 is a chassis domain electronic controller configured to control a front wheel steering system of the vehicle, and may be generally defined as an electric power steering (EPS) control unit. A front wheel steering angle electronic controller related to a front wheel steering angle may receive a steering wheel manipulation input (e.g., a steering torque sensor, a steering angle sensor) of a driver, and may determine a steering angle and steering torque required for front wheels by considering external environment data such as a driving speed, lateral acceleration, and a vehicle posture together. The front wheel steering angle electronic controller may drive an electric steering motor through a motor control circuit and a reduction gear control algorithm to optimize responsiveness and controllability of the vehicle. This unit is typically mounted near a steering gearbox or on a steering column, and may precisely perform front wheel steering even during autonomous driving through high-speed communication with the controller.

The electronic controller 120 may be a chassis domain electronic controller for controlling a rear wheel steering (RWS) system. A rear wheel steering angle electronic controller related to a rear wheel steering angle may collect data such as a driving speed of the vehicle, a front wheel steering angle, a yaw rate of the vehicle, and lateral acceleration in real time, and based on this, may determine a steering direction and a steering angle of rear wheels. By steering the rear wheels in a direction opposite to front wheels during low-speed driving and in the same direction as the front wheels during high-speed driving, it is possible to reduce a turning radius and secure high-speed driving stability. The rear wheel steering angle electronic controller may control a link or a camber arm of a rear wheel subframe through an electric actuator or a motor, and may be linked with a steer-by-wire (SbW) system. This unit may be disposed below the rear wheels or near an axle to perform roles such as individual control of the rear wheels and correction of a turning response during autonomous driving.

The controller 130 may integrally analyze and control large-scale data collected from the electronic controllers 120 distributed within the vehicle and the plurality of sensors 110. The controller 130 may be based on a multi-core high-reliability arithmetic chipset for vehicles in which an MPU and an MCU are integrated. The controller 130 is closely linked with an in-vehicle communication infrastructure and may concurrently serve as a gateway having multiple interfaces that concurrently (or in some cases, simultaneously) support various vehicle communication protocols such as CAN FD, FlexRay, and Automotive Ethernet. The controller 130 may efficiently manage an entire vehicle communication network, comprising functions such as traffic distribution among a plurality of ECUs, real-time message priority allocation, and bandwidth separation between diagnostic messages and control messages. The controller 130 may be expressed as a control unit, a control circuit, a control block, or the like.

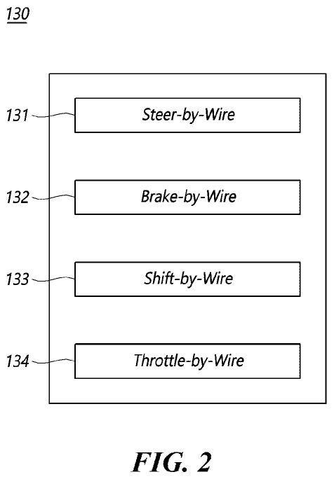

FIG. 2 illustrates the controller 130 according to embodiments of the present disclosure.

The controller 130 is an upper control system configured to perform comprehensive driving control of the vehicle, and may integrally control various functions such as autonomous driving, a safety assist system, and user-customized control, as well as basic driving functions of the vehicle. The controller 130 may comprise an electronic steering controller 131, an electronic braking controller 132, an electronic shift (or transmission) controller 133, and an electronic acceleration controller 134, and each component may be organically linked with individual sensors and actuators to control the vehicle.

The electronic steering controller 131 may be a steer-by-wire (SbW) system. The SbW system may be a method of performing steering based on an electric signal without mechanical connection parts such as a conventional steering shaft, pinion, and rack.

The electronic steering controller 131 may collect steering data by detecting a steering input of the driver through a steering angle sensor (e.g., a torque sensor or a rotation sensor).

After analyzing the steering data in real time, the electronic steering controller 131 may control an electric actuator (e.g., a rack drive motor or a wheel independent steering motor) based on the steering data. Accordingly, the electric actuator may control a wheel direction.

The electronic steering controller 131 controls steering by reflecting a vehicle speed, a road surface friction coefficient, lane information, a forward road curvature, and the like, and may perform automatic steering during autonomous driving without physical intervention of the driver.

The electronic braking controller 132 may be a brake-by-wire (BbW) system. The electronic braking controller 132 may detect a braking pedal manipulation of the driver through a brake pedal sensor and may collect braking data. The electronic braking controller 132 may be electrically connected to electronic braking actuators (e.g., an electric caliper, a hydraulic module, or an electric induction brake) installed on each wheel. The electronic braking controller 132 may control the electronic braking actuators to apply braking force based on the braking data.

The electronic braking controller 132 optimizes braking force by reflecting various information such as a road surface state (e.g., dry asphalt, a wet road, an icy road, etc.), a vehicle load, left and right centers of gravity, and a distance to a preceding vehicle, and is closely linked with an anti-lock braking system (ABS), an electronic stability control (ESC), an autonomous emergency braking (AEB) system, and the like. In addition, in an electric vehicle or a hybrid vehicle, braking efficiency may be increased by smoothly coordinating a transition between a regenerative braking function and mechanical braking.

The electronic braking controller 132 may set pedal sensitivity differently according to situations, and in an autonomous driving mode, may perform appropriate deceleration, stopping, and stop-hold functions without driver intervention. A redundancy configuration and a self-diagnosis function for system failure may also be basically comprised.

The electronic shift controller 133 may be a shift-by-wire (ShbW) system. The electronic shift controller 133 may detect a shift request of the driver as an electronic signal without a conventional mechanical shift link, transmit the electronic signal to a shift control unit, and control an operation of a powertrain.

The electronic shift controller 133 may control not only an automatic transmission but also a dual clutch transmission (DCT), a continuously variable transmission (eCVT), and a multi-stage motor drive system. The electronic shift controller 133 may select an appropriate shift strategy by synthesizing a current vehicle speed, acceleration, engine or motor output, RPM, a road slope, a vehicle mode (e.g., sport, eco), autonomous driving conditions, and the like.

The electronic acceleration controller 134 may be a throttle-by-wire (TbW) system. The electronic acceleration controller 134 may detect a depth or a position of an accelerator pedal with a sensor. The electronic acceleration controller 134 may control opening and closing of a throttle valve or control output of a motor based on the detected data. The electronic acceleration controller 134 may automatically control acceleration control during autonomous driving. The electronic acceleration controller 134 may finely control output according to a slope of a forward road or traffic flow. In the case of an electric vehicle, the electronic acceleration controller 134 may operate together with regenerative braking control in linkage with motor torque responsiveness.

The controller 130 integrally manages a plurality of X-by-Wire systems, and configures a control loop in which each control command is determined based on sensor input and environment information and transmitted to an actuator. Accordingly, stable and predictable vehicle control can be performed not only for driver-centric control but also under autonomous driving conditions.

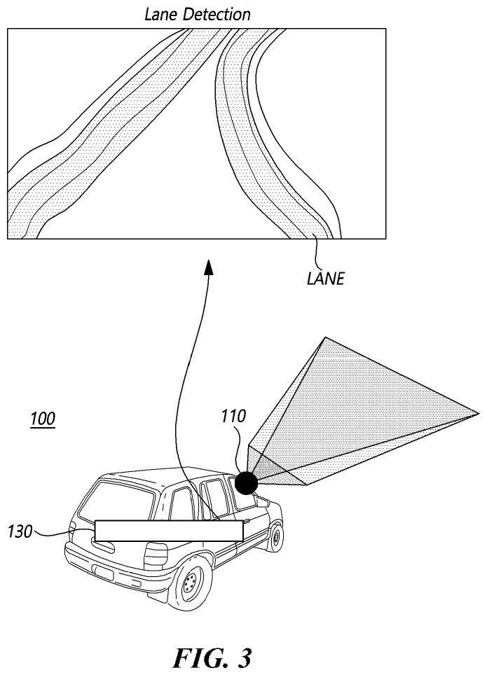

FIG. 3 illustrates a vehicle system 100 capable of autonomous driving according to embodiments of the present disclosure.

The vehicle system 100 according to the present disclosure may comprise an autonomous driving system. The autonomous driving system may comprise perception technology features, determination technology features, control technology, communication technology features, and security technology features.

The perception technology of the autonomous driving system may comprise a function of accurately sensing an environment around a vehicle and a current state of the vehicle. For this purpose, various sensors such as a camera, LiDAR, radar, an ultrasonic sensor, an inertial measurement unit (IMU), a GPS, a wheel speed sensor, and a steering angle sensor may be utilized. Information collected through a plurality of sensors is integrally processed through sensor fusion technology and may be used to recognize various objects such as lanes, road boundaries, vehicles, pedestrians, obstacles, and traffic lights.

The determination technology may comprise a function of determining an action of the vehicle based on perceived information. A determination algorithm may set an optimal path by considering a position of the vehicle, a destination, a road shape, movements of surrounding vehicles, and the like, and may perform determinations such as lane change, avoidance, and stopping during driving.

The control technology may be a technology for implementing a determination result as an actual vehicle operation. The vehicle system of the present disclosure may comprise an electronic steering controller (SbW), an electronic braking controller (BbW), an electronic shift controller (ShbW), and an electronic acceleration controller (TbW), all of which operate in an electronic control manner. These devices can control steering, braking, shifting, and acceleration of the vehicle using only electronic signals without physical connections.

The communication technology comprises a function in which the autonomous driving system exchanges information with the outside of the vehicle in real time. The present disclosure may comprise V2X (Vehicle-to-Everything)-based communication and may support various communication paths such as vehicle-to-vehicle (V2V), vehicle-to-infrastructure (V2I), and vehicle-to-network (V2N).

The security technology may comprise a function for ensuring stability and reliability of the overall system. The vehicle system of the present disclosure can protect the system from external attacks or hacking through a cybersecurity module, an authentication procedure, encrypted communication, and the like.

Referring to FIG. 3, the vehicle system 100 of the present disclosure may identify or detect a lane through a plurality of sensors 110. For example, a camera sensor may collect an image of the front or side of the vehicle and extract a position, a curve, a curvature, a lane color, a width, and the like in real time by applying a deep learning-based image recognition technique. In addition, a LiDAR sensor may determine a position of a lane boundary by analyzing a height or reflection characteristics of a road surface. If the GPS and the inertial sensor are used together, it is possible to precisely identify a lane departure degree of the vehicle deviated from the lane during actual driving, and this information can be used for lane keeping assist, lane change automation, road departure prevention control, and the like.

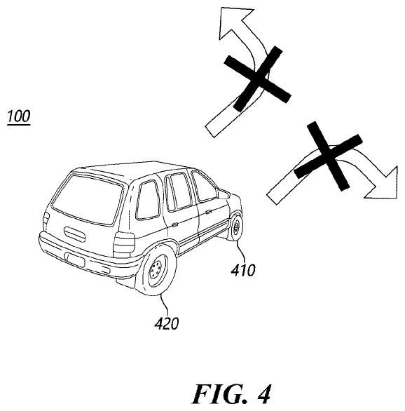

FIG. 4 is a diagram regarding some failure states of the vehicle system 100 according to embodiments of the present disclosure.

Referring to FIG. 4, the vehicle system 100 may adjust a driving direction of the vehicle by individually or selectively controlling a front wheel steering device 410 or a rear wheel steering device 420. Such a steering device may play a key role in performing operations such as path maintenance, lane change, and curve driving of the vehicle while performing an autonomous driving function.

The front wheel steering device 410 and the rear wheel steering device 420 may mean mechanical devices and electronic devices. In addition, the front wheel steering device 410 and the rear wheel steering device 420 may be meant to include electronic controllers. Hereinafter, unless otherwise specifically limited, it is assumed that the front wheel steering device 410 and the rear wheel steering device 420 include electronic controllers.

The vehicle system 100 may be mounted on a vehicle to which an autonomous driving system is applied, and the autonomous driving system may perform a function of recognizing, determining, and controlling various driving situations so that the vehicle can reach a final destination without driver intervention. In this case, the vehicle system 100 may recognize a lane based on information received from sensors and electronic controllers and control the vehicle to perform straight driving along the recognized lane. In addition, if a specific condition is satisfied, the vehicle system 100 determines to change a lane, and the front wheel steering device 410 or the rear wheel steering device 420 may be controlled to manipulate the vehicle to smoothly change the lane.

The vehicle system 100 may implement SbW technology through the electronic steering controller 131. The electronic steering controller 131 may generate and transmit a command for controlling the front wheel steering device 410 or rear wheel steering device 420. In particular, since the SbW system is a method of performing steering with sensors, actuators, and electronic controllers without a mechanical connection, reliability of communication and control may be very important. In a situation where the vehicle needs to drive in a curve section or change a lane, the vehicle system 100 may predict a driving path in advance, determine a target steering angle accordingly, and then precisely control the front wheel or rear wheel steering device 420 to implement the corresponding target steering angle.

Hereinafter, for convenience of description, description will be made based on a configuration in which the vehicle system controls the direction of the vehicle through the front wheel steering device 410. However, embodiments of the present disclosure may be equally applied to a configuration using the rear wheel steering device 420 and may also comprise an integrated steering system configuration in which front and rear wheel steering devices operate concurrently (or in some cases, simultaneously).

As shown in FIG. 4, a specific failure state may occur while the vehicle is driving. For example, the electronic steering controller 131 may not normally control the front wheel steering device 410 due to causes such as a communication error, electrical circuit damage, a failure of a sensor, or a mechanical defect of an actuator. In this case, the vehicle may not be able to drive along a planned path, and a direction change to the left or right may become impossible. Such a failure state has a problem that, especially when the failure occurs during high-speed driving or when entering a curve section or an intersection, which leads to a sudden loss of the traveling direction of the vehicle and causes a serious accident.

Embodiments of the present disclosure can provide a vehicle system capable of operating a failover even if a steering device has a failure or a defect.

Embodiments of the present disclosure can provide a vehicle system capable of maintaining steering of the vehicle even if a steering device has a failure or a defect.

Embodiments of the present disclosure can provide a vehicle system capable of stably maintaining autonomous driving even if a steering device has a failure or a defect during autonomous driving.

Hereinafter, the present disclosure will be described in further detail.

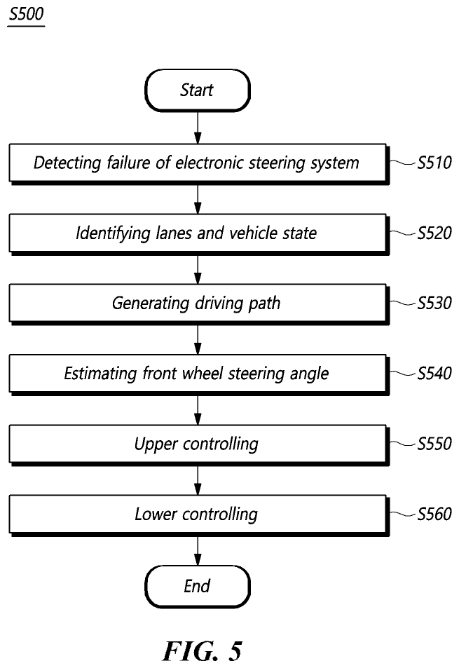

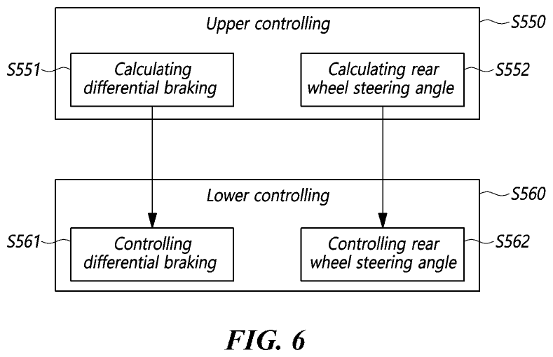

FIGS. 5 and 6 are flowcharts of an operating method (S500) of a vehicle according to embodiments of the present disclosure.

The operating method (S500) of the vehicle can comprise a step (S510) of determining whether a front wheel steering device is normally controlled, a step (S520) of identifying lanes and a vehicle state, a step (S530) of generating a driving path, a step (S540) of estimating a steering direction, a step (S550) of generating a steering control signal, and a step (S560) of controlling a braking state or a rear wheel steering angle.

The step (S510) of determining whether the front wheel steering device is normally controlled may be a step of detecting whether an error has occurred in the electronic steering controller 131. The vehicle system 100 may comprise an autonomous driving function and may depend on the front wheel steering device 410 for direction control of the vehicle. During autonomous driving, the vehicle system 100 may control the front wheel steering device 410 based on SbW and may comprise an error detection algorithm for determining whether a failure occurs in the steering system.

For example, the vehicle system 100 may determine whether a steering command is normally reflected by monitoring in real time a difference (e.g., steering response deviation) between a control command of the electronic steering controller 131 and a response value received from an actual steering angle sensor. In addition, a hardware or software failure of the electronic steering controller 131 may be quickly detected by analyzing together a current value of a steering motor, a torque sensor signal, a control communication delay, and whether a CAN communication error has occurred. The detected failure may be regarded as a failure when a threshold value of the aforementioned elements is exceeded or when an inoperable state persists for a specific period of time.

The step (S520) of identifying a lane and a vehicle state may be a step of detecting a position of a lane and a state of the vehicle. Even after a failure of the electronic steering controller 131 is detected, the vehicle system 100 may precisely recognize a surrounding environment and the state of the vehicle so as to stably maintain autonomous driving. To this end, a plurality of sensors 110 comprising a camera sensor and a LiDAR sensor mounted on a front of the vehicle may operate in fusion.

The vehicle system 100, based on information acquired from the sensors, may identify a lane shape of a road (e.g., whether straight or curved), a lane position, a lane width, and the like, and concurrently (or in some cases, simultaneously), may measure in real time a lateral displacement error from a lane centerline of the vehicle and an angle difference (e.g., heading angle) between a traveling direction of the vehicle and the lane centerline, and the like. Such dynamic state variables of the vehicle may be used as basic input values for a subsequent control step.

The path generation step (S530) may be a step of generating a traveling path of the vehicle. Since the vehicle system 100 needs to maintain autonomous driving despite a loss of function of the front wheel steering device 410, the vehicle system 100 may generate a virtual lateral trajectory in real time, considering a current road structure and traffic conditions. This path or trajectory may be generated considering various autonomous driving scenarios such as lane keeping, lane changing, and road curvature response, and may be optimized such that the vehicle satisfies targets such as minimum lateral acceleration and minimum steering angle change rate under given conditions.

The generated path, as a prediction-based path up to several meters ahead, may be continuously updated according to a current position and speed of the vehicle. This path can be utilized as a reference path for rear wheel steering angle control and differential braking control in a subsequent step.

The steering direction estimation step (S540) may be a step of estimating a front wheel steering angle at a time of failure. If an actual steering angle of a front wheel cannot be directly measured due to a failure of an SbW system, the vehicle system 100 may estimate the front wheel steering angle through an indirect estimation method. The vehicle system may, by synthesizing lateral acceleration, yaw rate, crosswind correction data, and the like, configure a lateral dynamic model capable of explaining behavior of the vehicle, and may estimate the front wheel steering angle through this.

In this process, by considering nonlinearity according to a vehicle speed, the process may be performed by dividing into a plurality of speed regions, and parameters of the dynamic model (e.g., tire cornering stiffness, etc.) may be learned based on a Linear Least Squares Method in each region. Furthermore, the vehicle system 100 may estimate complex vehicle behavior in real time by applying a deep learning-based regression neural network (e.g., an LSTM or CNN-based model), and may accurately predict the front wheel steering angle through this. In this case, reliability of the estimated model may be evaluated through statistical significance verification. As an example, a deep learning-based regression neural network for estimating the front wheel steering angle may be an artificial intelligence model that uses time series data such as lateral acceleration, yaw rate, and wheel speed according to a vehicle speed as input data, and an estimated front wheel steering angle as output data. In this case, the regression neural network may be a model pre-trained in a Supervised Learning manner for a correlation between sensor data (i.e., input data) collected in a normal driving state of the vehicle and an actual measured front wheel steering angle (i.e., a ground truth label), and may be an artificial intelligence model in which weights are updated to minimize a Loss Function.

The steering control signal generation step (S550) may be a step of generating a subsequent control signal such that the vehicle can follow the generated driving path. In this step, the vehicle system 100, based on a lateral vehicle dynamic model, may apply a Model Predictive Control (MPC) technique, considering six state variables (e.g., a lateral position of the vehicle, a lateral speed, a yaw angle of the vehicle, a yaw speed, a front wheel steering angle, a front wheel steering angle change rate, etc.). The MPC allows to predict vehicle behavior for several seconds in the future, and determine an optimal control input (e.g., a rear wheel steering angle, a braking torque, etc.) for path following.

An objective function of the MPC may comprise elements such as a path error, a steering response delay, ride comfort, and a tire load distribution, and through this, a control strategy may be established such that the vehicle follows a desired path most safely and smoothly. In this case, since front wheel steering is an impossible situation, ultimate steering control may be performed in a yaw moment control manner through rear wheel steering or differential braking torque.

The step of controlling the braking state or the rear wheel steering angle (S560) may be a step of controlling the rear wheel steering angle and differential braking. The rear wheel steering angle control signal and/or left and right differential braking torque control signal generated in the step of generating the steering control signal (S550) may be transmitted to corresponding control devices, respectively, to be converted into actual physical operations. For example, the vehicle system 100 may control a rack stroke position of the rear wheel steering device 420 by transmitting a target rear wheel steering angle to the rear wheel steering angle electronic controller 120, which is a control unit (e.g., RWS ECU) of a rear wheel steering (RWS) system. Concurrently (or in some cases, simultaneously), the brake electronic controller 120 for controlling brakes may receive left and right differential braking torque commands and induce a yaw moment of the vehicle by precisely controlling brake pressure of each wheel.

Such control of the braking state or the rear wheel steering angle requires fast responsiveness and precise operation, and a closed-loop control method based on sensor feedback may be applied. The vehicle system 100 may stably perform direction control of the vehicle even in a state where a failure of front wheel steering occurs and continuously follow an autonomous driving path by repeatedly performing this process.

Referring to FIG. 6, the step of generating the steering control signal (S550) may comprise a step of determining differential braking (S551) and a step of determining the rear wheel steering angle (S552).

Referring to FIG. 6, the step of determining differential braking (S551) may be a step of generating a differential braking control signal for differential braking. The differential braking control signal may be transmitted from the controller to the brake electronic controller 120 related to differential braking. The differential braking control step may be a step in which differential braking is applied to wheels of the vehicle. In the differential braking control step, the brake electronic controller 120 may control the wheels based on the differential braking control signal. Accordingly, the direction of the vehicle may be stably set.

Referring to FIG. 6, the step of determining the rear wheel steering angle (S552) may be a step of generating a rear wheel steering angle control signal for controlling the rear wheel steering angle. The rear wheel steering angle control signal may be transmitted from the controller to the rear wheel steering angle electronic controller 120 related to rear wheel steering angle control. The rear wheel steering control step may be a step in which a steering angle of the rear wheel steering device 420 of the vehicle is controlled. The rear wheel steering angle electronic controller 120 may control the rear wheel steering device 420 based on the rear wheel steering angle control signal. Accordingly, the direction of the vehicle may be stably set.

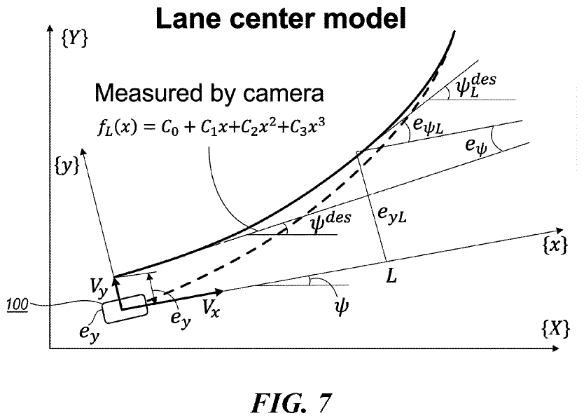

FIG. 7 is a diagram regarding a lane trajectory model of the vehicle system 100 according to embodiments of the present disclosure.

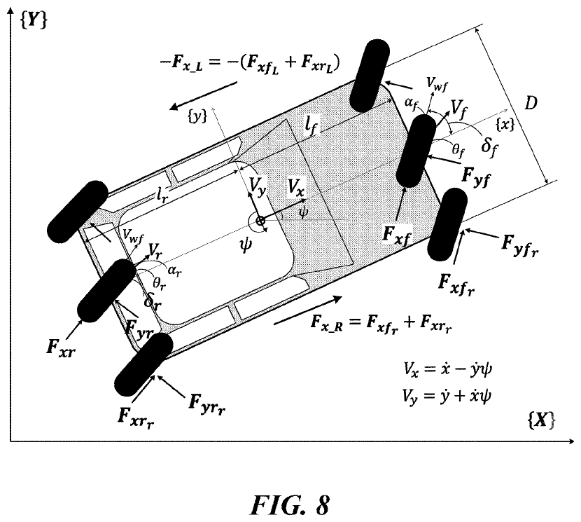

FIG. 8 is a diagram regarding vehicle dynamics modeling according to embodiments of the present disclosure.

Referring to FIG. 7, the vehicle system 100 may identify or detect a lane by applying a lane trajectory model after recognizing the lane with a camera sensor or a LiDAR sensor. Referring to FIG. 7, a lane trajectory model function may be expressed by F_{L}(x)=C₀+C₁x+C₂x²+C₃x³. Here, C₀ is a lateral offset, C₁ is a heading angle error, C₂ is a road curvature, and C₃ is a curvature rate. The vehicle system 100 may use the lane trajectory model function in the step of identifying the lane and the vehicle state (S520).

Referring to FIG. 8, it is illustrated a diagram related to vehicle dynamics modeling. The vehicle system 100 may use a lateral motion equation, a yaw motion equation, and the like in the step of identifying the lane and the vehicle state (S520).

The lateral motion equation may be as follows.

m(ÿ+\dot{x}\dot{ψ})=F_{yf}+F_{xf}·δ_{f}+F_{yr}−Fₓᵣ·δᵣ

The yaw motion equation may be as follows.

$${I}_{z} \dot{ψ} = {l}_{f} \cdot {F}_{yf} + {l}_{f} \cdot {F}_{xf} \cdot {δ}_{f} - {l}_{r} {F}_{yr} - {l}_{r} \cdot {F}_{xr} \cdot {δ}_{r} - \frac{D}{2} ( {F}_{x \_ L} - {F}_{x \_ R} )$$

$$\begin{matrix}{F}_{yf} = 2 \cdot {C}_{α f} \cdot {α}_{f} & where {α}_{f} = {δ}_{f} - {θ}_{f} \\ & {θ}_{f} ≃ ( \dot{y} + {l}_{f} \dot{ψ} ) / \dot{x}\end{matrix}$$

$$\begin{matrix}{F}_{yr} = 2 \cdot {C}_{α r} \cdot {α}_{r} & where {α}_{r} = {δ}_{r} - {θ}_{r} \\ & {θ}_{r} ≃ ( \dot{y} + {l}_{r} \dot{ψ} ) / \dot{x}\end{matrix}$$

$${F}_{xf} = {m}_{f} \cdot {a}_{wf} \qquad where {a}_{wf} = {r}_{eff} \cdot {\dot{ω}}_{wf}$$

$${F}_{xr} = {m}_{r} \cdot {a}_{wr} \qquad where {a}_{wr} = {r}_{eff} \cdot {\dot{ω}}_{wr}$$

Here, l_{f} may be a distance from a center of gravity to a front axle center, lᵣ may be a distance from the center of gravity to a rear axle center, D may be a tread (e.g., a distance between left and right wheels), Ψ may be a yaw angle, may be a yaw rate, Vx may be a longitudinal velocity of the vehicle, \dot{x} may be a lateral velocity of the vehicle, \dot{y} may be a time derivative of the lateral velocity, may be a time derivative of the longitudinal velocity, V_{wf} and V_{wr} may be velocities of front/rear wheels, α_{f} and αᵣ may be side-slip angles of the front/rear wheels, θ_{f} and θᵣ may be velocity angles of the front/rear wheels, δ_{f} and θ_{f} may be steer angles of the front/rear wheels, F_{yf} and F_{yr} may be lateral forces of the front/rear wheels, and F_{xf} and Fₓᵣ may be longitudinal forces of the front/rear wheels, F_{xf}_{_{L}}, F_{xF}_{ᵣ}, Fₓᵣ_{_{L}}, and Fₓᵣ_{ᵣ} may be longitudinal forces of left/right front wheels and left/right rear wheels, may be a sum of longitudinal forces and Car may be of left wheels, F_{x_r} may be a sum of longitudinal forces of right wheels, C_{αf} and C_{αr} lateral cornering stiffnesses of the front/rear wheels, m may be a mass (e.g., vertical load), α_{wf} and α_{wr} may be wheel accelerations of the front/rear wheels, reff may be an effective tire radius, \dot{w}_{wf} \dot{w}_{wr} and may be rotational wheel accelerations of the front/rear wheels, and Iz may be a yaw moment of inertia.

A state equation for \dot{X} lane recognition and vehicle state recognition may be as follows.

\dot{X}=AX+BU+Eδ_{f}

\dot{y}=a₁\dot{y}+a₂\dot{ψ}+b₁δᵣ+e₁δ_{f}

\ddot{ψ}=a₃\dot{y}+a₄\dot{ψ}+b₂ΔFₓ+e₂δ_{f}

Here, the input vector U is as follows.

$$U = [ \begin{matrix}{δ}_{r} \\ Δ {F}_{x}\end{matrix} ]$$

Here, δᵣ denotes the rear wheel steering angle, and AR denotes the differential braking force.

The error state equation e is as follows.

X, =AX, +BU_{fb}

Here, Xₑ is the error state vector, Xₑ is xₑ=(xₑ−x^{des}), and U_{fb} is the feedback input vector.

In addition, the following conditions are applied. This means that a basic principle of a state feedback controller is applied. The purpose of the controller is to minimize the error state vector, and K is designed according to performance (e.g., response speed, stability, etc.) of the system.

\dot{x}ₑ=(A−BK)Xₑ Controller:Find U=−KXₑto minimize Xₑ

The yaw motion equation is as follows.

$${I}_{z} \ddot{ψ} = {l}_{f} \cdot {F}_{yf} + {l}_{f} \cdot {F}_{xf} \cdot {δ}_{f} - {l}_{r} {F}_{yr} - {l}_{r} \cdot {F}_{xr} \cdot {δ}_{r} - \frac{D}{2} ( {F}_{x \_ L} - {F}_{x \_ R} )$$

$${I}_{z} \ddot{ψ} = {l}_{f} \cdot {F}_{yf} + {l}_{f} \cdot {F}_{xf} \cdot {δ}_{f} - {l}_{r} {F}_{yr} - {l}_{r} \cdot {F}_{xr} \cdot {δ}_{r} - \frac{D}{2} ( {F}_{{xf}_{L}} - {F}_{{xf}_{R}} + {F}_{{xr}_{L}} - {F}_{{xr}_{R}}$$

By rearranging the aforementioned equations, the following equation is derived.

$$\ddot{y} = \frac{- 2 ( {C}_{α f} + {C}_{α r} )}{m \dot{x}} \dot{y} + \{ - 1 - \frac{2 ( {C}_{α f} {l}_{f} - {C}_{α r} {l}_{r} )}{m {\dot{x}}^{2}} \} \dot{x} \dot{ψ} + ( \frac{2 {C}_{α f} + {mr}_{eff} {\dot{ω}}_{w}}{m} ) {δ}_{f} - ( \frac{2 {C}_{α r} + {mr}_{eff} {\dot{ω}}_{w}}{m} ) {δ}_{r}$$

$$\ddot{ψ} = \frac{- 2 ( {C}_{α f} {l}_{f} - {C}_{α r} {l}_{r} )}{{I}_{z} \dot{x}} \dot{y} + \frac{- 2 ( {C}_{α f} {l}_{f}^{2} + {C}_{α r} {l}_{r}^{2} )}{{I}_{z} \dot{x}} \dot{ψ} + \frac{{l}_{f} ( 2 {C}_{α f} + {mr}_{eff} {\dot{ω}}_{w} )}{{I}_{z}} {δ}_{f} - \frac{{l}_{r} ( 2 {C}_{α r} + {mr}_{eff} {\dot{ω}}_{w} )}{{I}_{z}} {δ}_{r} - \frac{D}{2 {I}_{z}} ( Δ {F}_{xf} + Δ {F}_{xr} )$$

That is, a system matrix (A) and an input matrix (B) of a state equation are derived as follows.

$$\frac{d}{\text{?}} [ \begin{matrix}y \\ \dot{y} \\ ψ \\ \dot{ψ} \\ {δ}_{f} \\ {\dot{δ}}_{f}\end{matrix} ] = [ \begin{matrix}0 & 1 & 0 & 0 & 0 & 0 \\ 0 & \text{?} & 0 & \text{?} & \text{?} & 0 \\ 0 & 0 & 0 & 1 & 0 & 0 \\ 0 & \text{?} & 0 & \text{?} & \text{?} & 0 \\ 0 & 0 & 0 & 0 & 0 & 1 \\ 0 & 0 & 0 & 0 & \text{?} & \text{?}\end{matrix} ] [ \begin{matrix}y \\ \dot{y} \\ ψ \\ \dot{ψ} \\ {δ}_{f} \\ {\dot{δ}}_{f}\end{matrix} ] + [ \begin{matrix}0 & 0 \\ \text{?} & 0 \\ 0 & 0 \\ \text{?} & \text{?} \\ 0 & 0 \\ \text{?} & \text{?}\end{matrix} ] [ \begin{matrix}\text{?} \\ \text{?}\end{matrix} ]$$

$$\text{?} \text{indicates text missing or illegible when filed}$$

Meanwhile, a lane keeping state vector Xₑ is as follows.

$${X}_{e} = [ \begin{matrix}{e}_{yL} \\ \dot{{e}_{y}} \\ {e}_{ψ} \\ \dot{ψ}\end{matrix} ] = [ \begin{matrix}{c}_{0} + {c}_{1} L + {c}_{2} {L}^{2} + {c}_{3} {L}^{3} \\ \dot{y} + \dot{x} {c}_{1} \\ {c}_{1} \\ \dot{ψ}\end{matrix} ]$$

### Lane Keeping Control

A lane change state vector X_{LC} is as follows.

$${X}_{LC} = [ \begin{matrix}{e}_{yL} + {y}_{L C} \\ \dot{{e}_{y}} \\ {e}_{ψ} \\ \dot{ψ}\end{matrix} ]$$

### Lane Changing Control

Here, a target lateral position y_{LC} during a lane change is

$${y}_{LC} = {y}_{d} [ \frac{{x}_{L C}}{{x}_{d}} - \frac{1}{2 π} sin ( \frac{2 π {x}_{LC}}{{x}_{d}} ) ] .$$

Here, y_{d} is a target lateral distance of the lane change (e.g., a lane width), X_{LC} is a travel distance (e.g., longitudinal) in a lane change section, xa is a total longitudinal distance required for the lane change, a_{yLC} is a maximum allowable lateral acceleration during the lane change, x̅_{sub} is a vehicle speed, g is gravitational acceleration, V_{LC} is an average speed during the lane change, and cₓ is an adjustment coefficient.

Finally, an error state equation \dot{X}ₑ as follows is derived.

$$\frac{d}{\text{?}} [ \begin{matrix}y \\ \dot{y} \\ ψ \\ \dot{ψ} \\ {δ}_{f} \\ {\dot{δ}}_{f}\end{matrix} ] = [ \begin{matrix}0 & 1 & 0 & 0 & 0 & 0 \\ 0 & \text{?} & 0 & \text{?} & \text{?} & 0 \\ 0 & 0 & 0 & 1 & 0 & 0 \\ 0 & \text{?} & 0 & \text{?} & \text{?} & 0 \\ 0 & 0 & 0 & 0 & 0 & 1 \\ 0 & 0 & 0 & 0 & \text{?} & \text{?}\end{matrix} ] [ \begin{matrix}y \\ \dot{y} \\ ψ \\ \dot{ψ} \\ {δ}_{f} \\ {\dot{δ}}_{f}\end{matrix} ] + [ \begin{matrix}0 & 0 \\ \text{?} & 0 \\ 0 & 0 \\ \text{?} & \text{?} \\ 0 & 0 \\ \text{?} & \text{?}\end{matrix} ] [ \begin{matrix}\text{?} \\ \text{?}\end{matrix} ]$$

$$\text{?} \text{indicates text missing or illegible when filed}$$

In addition, the vehicle system 100 may apply a discrete state space model, an incremental state space model, a predictive state space model, a cost function, and a control input determination. Equations related thereto are as follows.

### Discrete State Space Model

Xₖ₊₁=AXₖ+BᵤUₖ+BᵥVₖ

Yk=CXₖ

### Incremental State Space Model

$$\text{?}$$

$$Y = \overbrace{[ \begin{matrix}C & 0\end{matrix} ]}^{C} \text{?}$$

$$where$$

$$\text{?}$$

$$Nc : control horizon$$

$$N p : prediction horizon$$

$$\text{?} \text{indicates text missing or illegible when filed}$$

### Predictive State Space Model

$${\tilde{X}}_{ak + 1} = f {\tilde{X}}_{k} + g Δ {U}_{ak} + {hV}_{ak}$$

$${Y}_{ak} = {C}_{I} {\tilde{X}}_{ak + 1} = F {\tilde{X}}_{k} + G Δ {U}_{ak} + {HV}_{ak}$$

$$where$$

$${\tilde{X}}_{ak + 1} = [ \begin{matrix}{\tilde{X}}_{k + 1} \\ {\tilde{X}}_{k + 2} \\ {\tilde{X}}_{k + 3} \\ ⋮ \\ {\tilde{X}}_{k + Np}\end{matrix} ] , f = [ \begin{matrix}\tilde{A} \\ {\tilde{A}}^{2} \\ {\tilde{A}}^{3} \\ ⋮ \\ {\tilde{A}}^{Np}\end{matrix} ] ,$$

$$g = [ \begin{matrix}\tilde{{B}_{u}} & 0 & 0 & … & 0 \\ \tilde{A} \tilde{{B}_{u}} & \tilde{{B}_{u}} & 0 & … & 0 \\ {\tilde{A}}^{2} \tilde{{B}_{u}} & \tilde{A} \tilde{{B}_{u}} & \tilde{{B}_{u}} & … & 0 \\ ⋮ & ⋮ & ⋮ & ⋱ & ⋮ \\ {\tilde{A}}^{Np} \tilde{{B}_{u}} & {\tilde{A}}^{Np - 2} \tilde{{B}_{u}} & {\tilde{A}}^{Np - 3} \tilde{{B}_{u}} & … & {\tilde{A}}^{Np - Nc} \tilde{{B}_{u}}\end{matrix} ]$$

$$h = [ \begin{matrix}\tilde{{B}_{v}} & 0 & 0 & … & 0 \\ \tilde{A} \tilde{{B}_{v}} & \tilde{{B}_{v}} & 0 & … & 0 \\ {\tilde{A}}^{2} \tilde{{B}_{v}} & \tilde{A} \tilde{{B}_{v}} & \tilde{{B}_{v}} & … & 0 \\ ⋮ & ⋮ & ⋮ & ⋱ & ⋮ \\ {\tilde{A}}^{Np} \tilde{{B}_{v}} & {\tilde{A}}^{Np - 2} \tilde{{B}_{v}} & {\tilde{A}}^{Np - 3} \tilde{{B}_{v}} & … & \tilde{{B}_{v}}\end{matrix} ] ,$$

$$\text{?}$$

$$F = {C}_{I} f , G = {C}_{I} g , H = {C}_{I} h$$

$$\text{?} \text{indicates text missing or illegible when filed}$$

### Cost Function (Solve QP Problem)

$$Minimize ( {J}_{k} = {Y}_{ak}^{T} {QY}_{ak} + Δ {U}_{ak}^{T} R Δ {U}_{ak} )$$

$$\{ \begin{matrix}Δ {U}_{min} \leq Δ {U}_{ak} \leq Δ {U}_{max} \\ Δ {U}_{min} \leq {U}_{ak} \leq {U}_{max} \\ {Y}_{min} \leq {Y}_{ak} \leq {Y}_{max}\end{matrix} \begin{matrix}Control input ( with LTVKF ) \\ {δ}_{f}^{des} = {U}_{k} = {U}_{k - 1} + [ 1 , 0 , … , 0 ] Δ {U}_{ak}^{*}\end{matrix}$$

According to an embodiment of the present disclosure, the vehicle system 100 and a method (S500) of driving the vehicle are as follows.

The present disclosure relates to steering control of an autonomous vehicle, and more particularly, to a vehicle system 100 and a method (S500) for operating the vehicle for enabling autonomous driving to continue even when a front wheel steering device 410 does not operate normally.

The vehicle system 100 of the present disclosure may comprise an optical sensor as a plurality of sensors 110 configured to detect a lane that is a basis of a driving direction by an autonomous vehicle and to generate lane image data based thereon. The optical sensor may be, for example, a camera sensor, a LiDAR sensor, or a combination thereof. Lane image data acquired from the sensor is transmitted to a controller 130, and the controller 130 controls a front wheel steering device 410 of the vehicle based thereon.

However, if a failure occurs in the front wheel steering device 410 or if a communication error occurs between the controller 130 and the front wheel steering device 410, that is, if it is determined that the front wheel steering device 410 is not normally controlled, the controller 130 may set a steering direction of the vehicle based on a lateral vehicle dynamics model during a first period. To this end, the controller 130 receives necessary data from various sensors, such as an IMU, a wheel speed sensor, a steering angle sensor, and a brake pressure sensor, to determine the steering direction. The first period may be a period during which steps S520, S530, S540, and S550 shown in FIG. 5 proceed.

Thereafter, during a second period, to enable the vehicle to continue driving in the set steering direction, the controller 130 controls wheels of the vehicle or controls a rear wheel steering angle of a rear wheel steering device 420. In this case, the rear wheel steering angle control may be performed independently or concurrently (or in some cases, simultaneously) in parallel with the wheel control. The second period may be a period during which step S560 shown in FIG. 5 proceeds.

Such a control process may be divided into a steering control signal generation step (S550) and a braking state or rear wheel steering angle control step (S560). In the steering control signal generation step (S550), the controller 130 generates a driving path based on vehicle state and lane information, estimates a steering direction in which the vehicle should move, and generates a steering control signal corresponding thereto. Further, the steering control signal generation step (S550) may also comprise a step of determining a wheel braking force for differential braking or determining a rear wheel steering angle.

In the braking state or rear wheel steering angle control step (S560), according to the steering control signal, a brake electronic controller actually adjusts a braking force of each wheel, or a rear wheel steering angle electronic controller drives a rear wheel steering device 420 to control the vehicle. In particular, to continuously maintain autonomous driving of the vehicle, the vehicle may be controlled to drive along a lane through wheel control or rear wheel steering angle control, and may be controlled to perform a lane change if necessary.

As described above, the present disclosure proposes a control method that convergently utilizes rear wheel steering and wheel control to enable the vehicle to stably continue autonomous driving even in the event of a failure of a front wheel steering system, and may contribute to improving the safety and reliability of the vehicle.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vehicle system comprising:
an optical sensor configured to identify one or more lanes serving as a basis for a driving direction of a vehicle during autonomous driving, and generate lane image data; and
a controller configured to control a front wheel steering device of the vehicle based on the lane image data,
wherein, in response to the controller determining that the front wheel steering device is not normally controlled, the controller is configured to set a steering direction of the vehicle based on the lane image data in a first period, the first period being a period during which the steering direction is determined, and then control a braking state of one or more wheels of the vehicle or a rear wheel steering angle of a rear wheel steering device of the vehicle to determine a traveling direction of the one or more wheels based on the steering direction in a second period, the second period being a period subsequent to the first period during which the steering direction is applied.

2. The vehicle system of claim 1, wherein the controller is configured to control the one or more wheels to undergo differential braking in the second period.

3. The vehicle system of claim 1, wherein the controller is configured to concurrently control the braking state of the one or more wheels and the rear wheel steering device in the second period.

4. The vehicle system of claim 1, wherein the controller is configured to control the braking state of the one or more wheels or the rear wheel steering angle in the second period to control the vehicle such that the autonomous driving is maintained along the lanes.

5. The vehicle system of claim 1, wherein the controller is configured to control the braking state of the one or more wheels or the rear wheel steering angle in the second period to control the vehicle to change lanes by crossing any one of the lanes.

6. The vehicle system of claim 1, wherein the optical sensor is a camera sensor, a LiDAR sensor, or a combination thereof.

7. The vehicle system of claim 1, wherein a case where the controller determines that the front wheel steering device is not controlled comprises a case where a communication error occurs between the controller and the front wheel steering device.

8. The vehicle system of claim 1, wherein a case where the controller determines that the front wheel steering device is not controlled comprises a case where a failure occurs in the front wheel steering device.

9. The vehicle system of claim 1, wherein the controller is configured to determine the steering direction based on a lateral vehicle dynamics model in the first period, and
wherein the lateral vehicle dynamics model uses a model predictive control technique using state variables of a lateral position, a lateral velocity, a yaw angle, a yaw rate, a front wheel steering angle, and a front wheel steering angle change rate of the vehicle.

10. The vehicle system of claim 9, further comprising a plurality of sensors configured to measure the state variables to be used in the lateral vehicle dynamics model,
wherein the plurality of sensors comprise an IMU, a wheel speed sensor, a steering angle sensor, and a brake pressure sensor.

11. A method of driving a vehicle, the method comprising:
determining, by a controller, whether a front wheel steering device under electronic control is normally controlled;
identifying, by the controller, lane information including one or more lanes on which the vehicle is driving and a state of the vehicle;
generating, by the controller, a path along which the vehicle is to travel;
estimating, by the controller, a steering direction of the front wheel steering device;
generating, by the controller, a steering control signal such that the vehicle moves in the steering direction; and
controlling, by the controller, a braking state of one or more wheels of the vehicle or a rear wheel steering angle of a rear wheel steering device to determine a traveling direction of the one or more wheels based on the steering control signal.

12. The method of claim 11, wherein, in the determining of whether the front wheel steering device is normally controlled,
the controller determines that the front wheel steering device is in an abnormal state in response to a communication error occurring between the controller and the front wheel steering device or in response to a failure occurring in the front wheel steering device.

13. The method of claim 11, wherein, in the estimating of the steering direction, the controller determines the steering direction based on a lateral vehicle dynamics model, and
wherein the lateral vehicle dynamics model uses a model predictive control technique using state variables of a lateral position, a lateral velocity, a yaw angle, a yaw rate, a front wheel steering angle, and a front wheel steering angle change rate of the vehicle.

14. The method of claim 11, wherein, in the identifying of the lane information and the state of the vehicle, and
wherein the controller receives lane image data from an optical sensor for detecting lanes.

15. The method of claim 14, wherein the optical sensor is a camera sensor, a LiDAR sensor, or a combination thereof.

16. The method of claim 11, wherein, in the controlling,
the controller controls the braking state of the one or more wheels or the rear wheel steering angle to control the vehicle such that autonomous driving is maintained along lanes.

17. The method of claim 11, wherein, in the controlling,
the controller controls the braking state of the one or more wheels or the rear wheel steering angle to control the vehicle to change lanes by crossing any one of the lanes.

18. The method of claim 11, wherein the generating of the steering control signal comprises determining, by the controller, a braking force to be applied to the one or more wheels, and
wherein the controlling comprises controlling, by a brake electronic controller, the one or more wheels to undergo differential braking.

19. The method of claim 11, wherein the generating of the steering control signal comprises determining, by the controller, the rear wheel steering angle, and
wherein the controlling comprises controlling, by a rear wheel steering angle electronic controller, the rear wheel steering angle of the rear wheel steering device.

20. The method of claim 11, wherein, in the controlling,
the controller concurrently controls the braking state of the one or more wheels and the rear wheel steering device.
